(19) United States
(12) Patent Application Publication
(10) Pub. No.: US 2021/0306805 A1
(43) Pub. Date: Sep. 30, 2021

(54) SYSTEM AND METHOD FOR CLIENT-SERVER CONNECTION AND DATA DELIVERY BY GEOGRAPHICAL LOCATION

(71) Applicant: Wander Realty, LLC, Health, OH (US)

(72) Inventor: Robert Dawson, Granville, OH (US)

(73) Assignee: Wander Realty, LLC, Heath, OH (US)

(21) Appl. No.: 17/206,210

(22) Filed: Mar. 19, 2021

Related U.S. Application Data
(60) Provisional application No. 63/001,600, filed on Mar. 30, 2020.

(51) Int. Cl. H04W 4/029; G06T 19/00; H04W 4/02; G02B 27/01

(52) U.S. Cl. CPC H04W 4/029; G02B 27/017; H04W 4/025; G06T 19/006

(57) ABSTRACT

A system and method for providing a client-server connection corresponding to a geographic location is disclosed. A spatial domain system stores a plurality of registrations of spatial domains comprising virtual three-dimensional volumes corresponding to a real-world geographical space. A client is configured to transmit the spatial domains to an augmented reality system and a spatial domain registry database stores a plurality of spatial domain information. An analysis system interprets the spatial domain to permit the support of vertically stacked, overlapping, and/or intersecting spatial domains. A server transmits the spatial domain to the computing device whereon the user interacts with a plurality of augmented reality objects provided via a display of a real-world environment correlating to the spatial domain.

### CROSS-REFERENCE TO RELATED APPLICATIONS

The present application claims priority to U.S. Provisional Patent Application 63/001,600 filed on Mar. 30, 2020, entitled “SYSTEM AND METHOD FOR CLIENT-SERVER CONNECTION BY GEOGRAPHICAL LOCATION” the entire disclosure of which is incorporated by reference herein.

### TECHNICAL FIELD

The embodiments generally relate to systems for establishing a client-server connection and, more specifically, relate to systems for establishing the client-server connection and delivering data based on a geographic location.

### BACKGROUND

Augmented reality is an emerging technology in commercial and enterprise applications and is expected to soon become available to the average consumer. Augmented reality functions by overlaying virtual “augmented” information onto a view of the real physical world through the use of an electronic device such as augmented reality glasses, smart phones, tablets, or other electronic devices (collectively referred to herein as “AR clients”, or simply “clients”) having the ability to receive information from the surrounding environment. This technology provides an interactive experience with a real-world environment where the objects that reside in the real world are enhanced by computer-generated perceptual information, sometimes across multiple sensory modalities including visual, auditory, haptic, somatosensory and olfactory. Similar technologies to augmented reality include extended reality, virtual reality, mixed reality, and spatial computing.

Because augmented reality incorporates a view of the user's surrounding environment, users are able to travel between and throughout a geographical space while interacting with both the augmented space and the physical space. As the user moves through various locations, AR clients need a reliable way to obtain augmented reality content relevant to the current geographical location in which the user is interacting.

To function, augmented reality systems include various hardware components including mobile computing devices, cameras, microelectromechanical systems sensors (e.g., accelerometers), GPS, and solid-state compasses contained in the mobile computing devices. A display may be used including mobile device displays, eyeglasses, heads-up display units, contact lenses, and similar technologies capable of displaying an image.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a system for establishing the client-server connection and delivering data based on a geographic location. A spatial domain system stores a plurality of registrations of spatial domains comprising virtual three-dimensional volumes corresponding to a real-world geographical space. A client is configured to transmit the spatial domains to an augmented reality system, and a spatial domain registry database stores a plurality of spatial domain information, server references, and/or server permissions. An analysis system interprets the spatial domain to permit the support of vertically stacked, overlapping, and/or intersecting spatial domains. A server transmits the spatial domain to the computing device whereon the user interacts with a plurality of objects provided via a display of a virtual environment overlaying real-world environment correlating to the spatial domain.

In one aspect, the system is configured as an extended reality system, a virtual reality system, a mixed reality system, or a spatial computing system.

In one aspect, the client may include drones and/or robots. In such, the system and methods described herein may be used in the drone flight and aviation systems, including training systems thereof. Further, the system may be used as a supplemental system to the robotics industry. In another aspect, the system may be utilized by the artificial intelligence industry.

The system allows for the user to engage with an augmented reality application provided on the client device such that the user may interact with the augmented reality objects while maintaining engagement with the real-world environment.

The system may also store geographic location information for locations remote from the user and client device. In such, a database stores the location information and provides the location information to the display of the client device.

In one aspect, the spatial domains comprise a set of longitude and latitude coordinates. Further, an altitude value may be provided with the spatial domains.

In one aspect, the client device is a pair of augmented reality-enabled eyeglasses, a smartphone, a tablet, or another computing device capable of communicating with the spatial domain system.

In one aspect, the client requests an updated domain list while moving through the real-world environment.

A method for providing a client-server connection corresponding to a geographic location is disclosed. The spatial domain system receives a plurality of registrations of spatial domains comprising virtual three-dimensional volumes corresponding to a real-world geographical space. Spatial domains are transmitted to a display system. The display system may correspond to an augmented reality system, extended reality system, mixed reality system, virtual reality system, spatial computing system. A spatial domain registry database stores a plurality of spatial domain information. The analysis system interprets the spatial domain to permit the support of vertically stacked spatial domains. A server then transmits the spatial domain to the computing device whereon the user interacts with a plurality of objects provided via a display of a real-world environment correlating to the spatial domain.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the system, according to some embodiments;

FIG. 2 illustrates a block diagram of the network infrastructure, according to some embodiments;

FIG. 3 illustrates a flowchart of a method for providing a client-server connection corresponding to a geographic location, according to some embodiments; and

FIG. 4 illustrates a block diagram of the application system and client input/output devices, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “augmented reality (AR) client” or simply “client” is used to define the computing device operating the augmented reality application system. For example, the AR client may be a smartphone, mobile computer, tablet, eyeglasses, or other mobile computing devices.

In general, the embodiments provided herein relate to a system and method for a client-server connection based on the geographic location of the AR client. A spatial domain system comprises virtual three-dimensional volumes which correspond to real-world geographical space and host computer system addresses (referred to herein as “hosts”), which provide spatial information in the form of two-dimensional or three-dimensional assets and data for those volumes.

In some embodiments, a client provides a set of geographical coordinates to the system and receives a set of spatial domains indicating that the client is currently within the set of spatial domains. This allows the client to freely transition between different information sets from different servers by simply moving around the real physical world. As the client's geographical coordinates change, the client can request updated information based on which spatial domains the coordinates currently intersect.

The client device is operable to provide direct or indirect views of a real-world environment along with digitally projected augmented objects to provide a display that integrates real-world objects and computer-generated objects. As a result, augmented reality devices can operate as scene-aware devices that have an understanding of a real-world environment as an augmented reality environment or virtual environment supported by the augmented reality device.

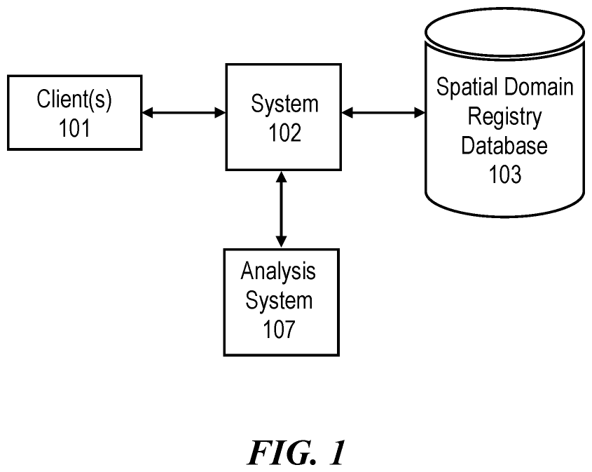

FIG. 1 illustrates a block diagram of the spatial domain system 102 that receives and stores geophysical coordinates each comprising latitude, longitude, and altitude from the client 101 which is provided in the form of a GeoURI compliant with RFC 5870 or other suitable uniform resource identifier (URI) schemes. Once the spatial domain system receives the coordinates, the system 102 queries a spatial domain registry database 103 for any domains that the coordinate intersects. The spatial domain registry database 103 returns any domains whose geometry is intersected by the coordinate using two-dimensional spherical (or non-spherical) surface geometry representing the surface of the Earth or other spherical body. The domains are further passed to the analysis system 107. The altitude of the coordinate is further checked against altitude bounds for each intersected domain's geometry which allows the system to support vertically stacked domains such as a high-rise office or apartment building wherein multiple individuals or businesses occupy the same latitude and longitude but exist on different floors of the building. Fully intersecting domains are then returned to the system 102 for delivery to the client 101. The system 102 then packages the spatial domain information and returns the spatial domain information to the client 101. As the client 101 moves in the real-world space, the client's 101 geographic coordinates will change and the client 101 can request an updated domain list.

The client 101 is operated by a user having downloaded a software system on an augmented reality-capable device, such as a smartphone, augmented reality glasses, or likewise devices to interact with the system 102. The client 101 obtains its geographic location through the use of various sensors and systems, such as GPS, cellular tower connection data, and like systems. The location data is then transmitted to a predetermined server over the internet. In some embodiments, the spatial domain system network may be organized by geographical location and the client may select a server to connect to based on proximity. The server responds with a list of registered volumes that the location indicated by the location data intersects which includes host server addresses for each volume. The client software may then connect to the hosts on the list to retrieve augmented reality content and render it into the user's view. The system receives the user's location in real-time via the computing device associated with the user. The client transmits a request to the server as described hereinabove for each new location.

In some embodiments, the volume may include various three-dimensional shapes in a spherical coordinate system. For example, the volumes may be prisms, or more complex shapes.

In some embodiments, the system described hereinabove may be used by software systems which are not using the location of the computing device. For example, the user may select a geographic location which corresponds to information stored in the database such as information containing an environment corresponding to New York City. In this example, the user may interact with a virtual reality device to move or otherwise interact virtually throughout the user-specified geographic location.

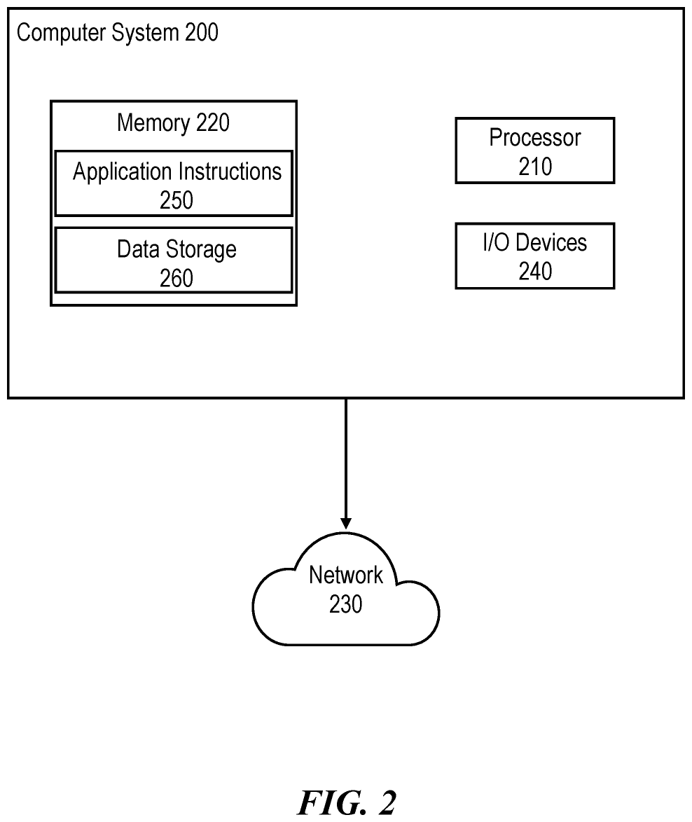

FIG. 2 illustrates a computer system 200, which may be utilized to execute the processes described herein. The computer system 200 is comprised of a standalone computer or mobile computing device, a mainframe computer system, a workstation, a network computer, a desktop computer, a laptop, or the like. The computer system 200 includes one or more processors 210 coupled to a memory 220 via an input/output (I/O) interface. Computer system 200 may further include a network interface to communicate with the network 230. One or more input/output (I/O) devices 240, such as video device(s) (e.g., a camera), audio device(s), and display(s) are in operable communication with the computer system 200. In some embodiments, similar I/O devices 240 may be separate from computer system 200 and may interact with one or more nodes of the computer system 200 through a wired or wireless connection, such as over a network interface.

Processors 210 suitable for the execution of a computer program include both general and special purpose microprocessors and any one or more processors of any digital computing device. The processor 210 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive). In some embodiments, the system described herein is applicable to drones, robots, artificial intelligence engines, and the like.

A network interface may be configured to allow data to be exchanged between the computer system 200 and other devices attached to a network 230, such as other computer systems, or between nodes of the computer system 200. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 220 may include application instructions 250, configured to implement certain embodiments described herein, and a database 260, comprising various data accessible by the application instructions 250. In one embodiment, the application instructions 250 may include software elements corresponding to one or more of the various embodiments described herein. For example, application instructions 250 may be implemented in various embodiments using any desired programming language, scripting language, or combination of programming languages and/or scripting languages (e.g., C, C++, C#, JAVA®, JAVASCRIPT®, PERL®, etc.).

The application instructions 250 include instructions to provide an augmented reality experience to the user via the client. The augmented reality experience may include augmented reality objects projected onto a real-world environment display or view of the real-world environment.

The steps and actions of the computer system 200 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 210 such that the processor 210 can read information from, and write information to, the storage medium. In the alternative, the storage medium may be integrated into the processor 210. Further, in some embodiments, the processor 210 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

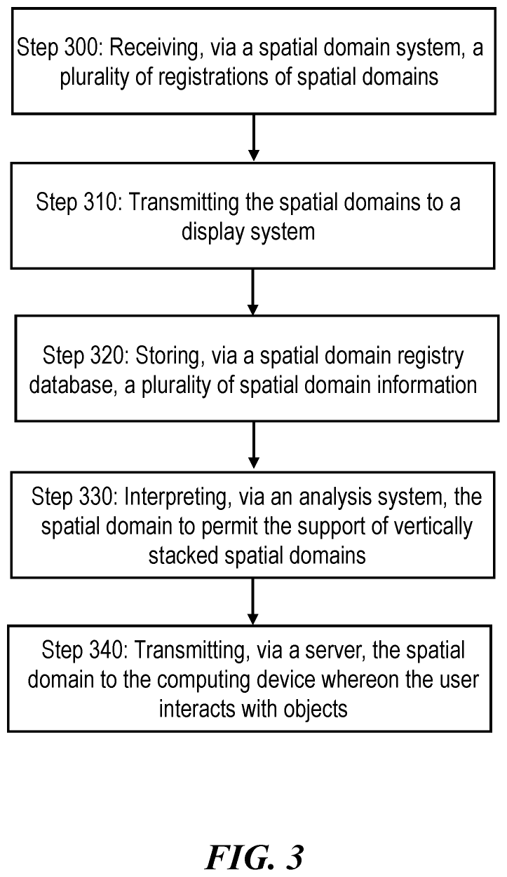

FIG. 3 illustrates a flowchart of the method for providing a client-server connection corresponding to a geographic location. In step 300, the spatial domain system receives a plurality of registrations of spatial domains comprising virtual three-dimensional volumes corresponding to a real-world geographical space. In step 310, the spatial domains are transmitted to a display system. The display system may correspond to an augmented reality system, extended reality system, mixed reality system, virtual reality system, or spatial computing system. In step 320, a spatial domain registry database stores a plurality of spatial domain information. In step 330, the analysis system interprets the spatial domain to permit the support of vertically stacked spatial domains. In step 340, a server then transmits the spatial domain to the computing device whereon the user interacts with a plurality of objects provided via a display of a real-world environment correlating to the spatial domain.

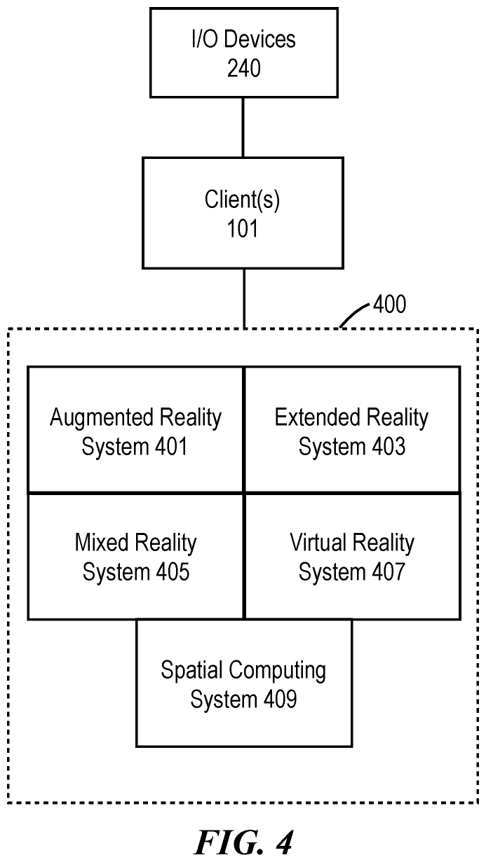

FIG. 4 illustrates a block diagram of the application system 400 which may operate an augmented reality system 401, extended reality system 403, mixed reality system 405, virtual reality system 407, and/or a spatial computing system 409. The client(s) 101 may be in operable communication with the I/O devices 240 which are utilized by the user when engaging with the application system 400. The I/O devices 240 may include headsets, speakers, headphones, displays, etc. The I/O devices may be used to interact with one or more of the augmented reality system 401, extended reality system 403, mixed reality system 405, virtual reality system 407, and/or the spatial computing system 409. The client 101 may include various forms of computing devices, robotic devices, and aircraft (e.g., drones).

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A method for establishing a client-server connection and delivering data corresponding to a geographic location, the method comprising the steps of:
receiving, via a spatial domain system, a plurality of registrations of spatial domains comprising virtual three-dimensional volumes corresponding to a real-world geographical space;
transmitting the spatial domains to an application system;
storing, via a spatial domain registry database, a plurality of spatial domain information;
interpreting, via an analysis system, the spatial domain to permit the support of vertically stacked, overlapping, and/or intersecting spatial domains;
transmitting, via a server, the spatial domain to the computing device whereon the user interacts with a plurality of objects provided via a display of a real-world environment correlating to the spatial domain.

2. The method of claim 1, wherein the spatial domains comprise a set of longitude and latitude coordinates.

3. The method of claim 2, wherein the spatial domains further comprise an altitude value.

4. The method of claim 1, wherein the client is a pair of augmented reality-enabled eyeglasses.

5. The method of claim 1, wherein the client is a computing device.

6. The method of claim 1, wherein the client is a computing device having capabilities to perform at least one of the following: augmented reality, virtual reality, extended reality, and spatial computing.

7. The method of claim 1, wherein the client is a drone.

8. The method of claim 1, wherein the client is a robot.

9. The method of claim 1, further comprising the step of requesting an updated domain list while moving through the real-world environment.

10. A system for establishing a client-server connection and delivering data corresponding to a geographic location, the system comprising:
a spatial domain system to store a plurality of registrations of spatial domains comprising virtual three-dimensional volumes corresponding to a real-world geographical space;
a client configured to transmit the spatial domains to a display system;
a spatial domain registry database to store a plurality of spatial domain information;
an analysis system to interpret the spatial domain to permit the support of vertically stacked, overlapping, and/or intersecting spatial domains;
a server to transmit the spatial domain to the computing device whereon the user interacts with a plurality of virtual objects provided via a display of a real-world environment correlating to the spatial domain.

11. The system of claim 10, wherein the volume includes one or more three-dimensional shapes in a spherical coordinate system.

12. The system of claim 10, wherein the spatial domains comprise a set of longitude and latitude coordinates.

13. The system of claim 12, wherein the spatial domains comprise an altitude value.

14. The system of claim 10, wherein the client requests an updated domain list while moving through the real-world environment.

15. The system of claim 10, wherein the client is a computing device.

16. The system of claim 15, wherein the client is a computing device having capabilities to perform at least one of the following: augmented reality, virtual reality, extended reality, and spatial computing.

17. The system of claim 15, wherein the client transmits a request to the server to receive a spatial domain corresponding to each of a plurality of locations.

18. The system of claim 15, wherein the client is operable to provide direct or indirect views of a real-world environment.

19. The system of claim 18, wherein the client is operable to digitally projected objects to provide a display including at least one real-world object and at least one computer-generated object.

20. A system for establishing a client-server connection and delivering data corresponding to a geographic location, the system comprising:
a spatial domain system to store a plurality of registrations of spatial domains comprising virtual three-dimensional volumes corresponding to a real-world geographical space;
a client configured to transmit the spatial domains to at least one of the following: an augmented reality system, an extended reality system, a virtual reality system, a mixed reality system, and a spatial computing system;
a spatial domain registry database to store a plurality of spatial domain information;
an analysis system to interpret the spatial domain to permit the support of a vertically stacked spatial domain, via an altitude value; and
a server to transmit the spatial domain to the computing device whereon the user interacts with a plurality of virtual objects provided, via the display system, within a real-world environment correlating to the spatial domain.
